(19) United States
(12) Patent Application Publication
(10) Pub. No.: US 2026/0233732 A1
(43) Pub. Date: Aug. 13, 2026

(54) METHOD FOR THE AT LEAST HIGHLY AUTOMATED DRIVING AND FOR THE INFRASTRUCTURE-SUPPORTED ASSISTING OF A MOTOR VEHICLE WITHIN A PARKING SPACE

(71) Applicant: Robert Bosch GmbH, Stuttgart-Feuerbach (DE)

(72) Inventors: Stefan Nordbruch, Leonberg (DE); Nico Latsch, Oppenweiler (DE); Felix Hess, Benningen (DE); Michael Gabb, Gäufelden (DE); Sebastian Hahn, Sindelfingen (DE); Sascha Muehlbrandt, Wiernsheim (DE); Carsten Haemmerling, Gärtringen (DE)

(21) Appl. No.: 19/153,457

(22) PCT Filed: Aug. 19, 2024
(86) PCT No.: PCT/EP2024/073212

§ 371 Date: Aug. 4, 2025

(30) Foreign Application Priority Data
Aug. 22, 2023 (DE) 10 2023 122 469.7

(51) Int. Cl. B60W 30/06; H04W 4/44

(52) U.S. Cl. CPC B60W 30/06; H04W 4/44; B60W 2555/60; B60W 2556/40; B60W 2556/45

(57) ABSTRACT

The invention relates to a method for the infrastructure-supported assisting of a motor vehicle for at least highly automated driving in accordance with AVP type 1 within a region of a parking space, wherein AVP type 1 is a motor-vehicle centred AVP process, comprising the following steps: sending, by an infrastructure-side AVP system, infrastructure assistance data to the motor vehicle on the basis of which the motor vehicle can drive at least highly automatedly within the region in accordance with AVP type 1. The invention also relates to a method for the at least highly automated driving of a motor vehicle, to an AVP system for an infrastructure, to an AVP system for a motor vehicle, to a motor vehicle, to a computer program and to a machine-readable storage medium.

The invention relates to a method for infrastructure-based assistance of a motor vehicle, to a method for at least highly automated driving of a motor vehicle, to an AVP system for an infrastructure, to an AVP system for a motor vehicle, to a motor vehicle, to a computer program and to a machine-readable storage medium.

The patent application claims the priority of the German patent application 10 2023 122 469.7, the disclosure content of which is hereby incorporated by reference

The abbreviation “AVP” stands for “Automated Valet Parking”. An AVP process comprises, for example, at least highly automated guidance of the AVP motor vehicle from a drop zone, also called a drop-off position or drop-off zone, to a parking position and, for example, at least highly automated guidance of the motor vehicle from a parking position to a pick-up position, also called a pick-up zone. At the drop-off position, i.e. the drop zone, a driver of the motor vehicle drops off the motor vehicle for an AVP process. At a pick-up position, i.e. the pick-up zone, the motor vehicle is picked up after the end of the AVP process. Thus, an AVP process starts in particular at the drop zone. An AVP process therefore ends in particular at the pick-up zone. The pick-up zone can be the same as or different from the drop zone.

An AVP motor vehicle is therefore a motor vehicle that can participate in an AVP process.

### PRIOR ART

The published patent application DE 10 2012 222 562 A1 shows a system for managed parking spaces for transferring a vehicle from a starting position to a target position.

An AVP process can be an AVP process according to one of the following AVP types: AVP type 1, AVP type 2, and AVP type 3.

AVP type 1 denotes a motor-vehicle-centric AVP process. The primary responsibility for the AVP process lies with the motor vehicle.

AVP type 2 denotes an infrastructure-centric AVP process. The primary responsibility for the AVP process lies with the infrastructure, i.e. the AVP system.

AVP type 3 denotes an AVP process split between the motor vehicle and the infrastructure. Here, a primary responsibility for the AVP process is split between the motor vehicle and the AVP system.

When the motor vehicle drives according to AVP type 2, provision is made for the infrastructure to detect an object and/or an event and to react accordingly to a detected object and/or a detected event. For this purpose, a plurality of environmental sensors are arranged within the parking area, the environmental sensor data from which are used as a basis for object detection or event detection.

When the motor vehicle drives according to AVP type 1, provision is usually made for the motor vehicle to detect an object and/or an event on the basis of its own environmental sensors and to react accordingly to a detected object and/or a detected event. In other words, driving according to AVP type 1 does not usually require any environmental sensors in the parking area.

However, there may be regions within the parking area that are complex and/or that may lead to situations that are easier to cope with by driving according to AVP type 2 using environmental sensors in the parking area than if the motor vehicle relies only on its own environmental sensors. Such regions include, for example, a drop zone, i.e. a region where a driver parks his motor vehicle for the AVP process, or parking bays or a region in front of a stairwell or an elevator, since more people can be expected here at once than in the rest of the parking garage.

Equipping all regions of the parking area, i.e. even those regions that the motor vehicle could easily drive through at least in a highly automated manner even without environmental sensors in the parking area, with environmental sensors is technically complex and expensive.

There is therefore a need to overcome these disadvantages.

### DISCLOSURE OF THE INVENTION

The object on which the invention is based is to provide a concept which allows a motor vehicle to drive within a region of a parking area in an at least highly automated manner according to AVP type 1.

This object is achieved by way of the respective subject matter of the independent claims. Respective dependent subclaims relate to advantageous configurations of the invention.

A first aspect provides a method for infrastructure-based assistance of a motor vehicle for an at least highly automated journey according to AVP type 1 within a region of a parking area, wherein AVP type 1 is a motor-vehicle-centric AVP process, comprising the following step of:
an infrastructure AVP system sending infrastructure assistance data to the motor vehicle, on the basis of which the motor vehicle can drive in an at least highly automated manner according to AVP type 1 within the region.

A second aspect provides a method for at least highly automated driving of a motor vehicle according to AVP type 1 within a region of a parking area, comprising the following steps of:
a motor vehicle AVP system of the motor vehicle receiving infrastructure assistance data from an infrastructure AVP system of the parking area, on the basis of which the motor vehicle AVP system can drive the motor vehicle in an at least highly automated manner according to AVP type 1 within the region, the motor vehicle AVP system driving the motor vehicle in an at least highly automated manner according to AVP type 1 within the region based on the infrastructure assistance data.

A third aspect provides an AVP system for an infrastructure, in particular a parking area, which is configured to carry out all the steps of the method according to the first aspect.

A fourth aspect provides an AVP system for a motor vehicle, wherein the AVP system is configured to carry out all the steps of the method according to the second aspect.

A fifth aspect provides a motor vehicle comprising the AVP system according to the fourth aspect.

A sixth aspect provides a computer program comprising instructions which, when the computer program is executed by a computer, cause the latter to carry out a method according to the first aspect and/or according to the second aspect.

A seventh aspect provides a machine-readable storage medium on which the computer program according to the sixth aspect is stored.

The invention is based on and includes the finding that the above object is achieved by virtue of the fact that the motor vehicle or the motor vehicle AVP system is provided with information, the infrastructure assistance data, for the AVP type 1 journey within the region by the infrastructure, i.e. the infrastructure AVP system, even though it does not actually need this information because of the motor-vehicle-centric journey. This information provided by the infrastructure allows the motor vehicle AVP system for driving the motor vehicle according to AVP type 1 to resort to more information than without this information. For example, a scope for the journey can therefore be extended. For example, the journey can therefore be planned or adjusted in a particularly efficient manner by the motor vehicle AVP system. For example, safety for the motor vehicle and its surroundings can therefore be increased.

A region within which the motor vehicle drives according to AVP type 1 does not need to be equipped with environmental sensors that monitor this region. The reason is that AVP type 1 is motor-vehicle-centric driving. The responsibility for driving lies solely with the motor vehicle AVP system. For driving, the motor vehicle uses its own environmental sensors that capture an environment of the motor vehicle. Based on this capture, the motor vehicle drives according to AVP type 1.

A region within which the motor vehicle drives according to AVP type 2 must be equipped with environmental sensors that monitor this region. The reason is that AVP type 2 is infrastructure-centric driving. The responsibility for driving lies solely with the infrastructure, in this case with the infrastructure AVP system. So that the motor vehicle can drive in an infrastructure-centric manner according to AVP type 2, certain information (infrastructure assistance data) must be sent from the infrastructure to the motor vehicle. In order to be able to determine this information, information is required about the region within which the motor vehicle is intended to drive according to AVP type 2. This information is determined, for example, using one or more environmental sensors that monitor this region. Thus, for example, the infrastructure knows whether there is a potential collision object for the motor vehicle within the region and can accordingly determine a target trajectory for circumventing the collision object for the motor vehicle and send it to the motor vehicle.

Thus, regions of the parking area can be equipped with environmental sensors that monitor these regions within which the motor vehicle drives in an at least highly automated manner according to AVP type 2. Thus, it is possible to provide regions of the parking area which are not equipped with environmental sensors, that is to say are not monitored by environmental sensors in the parking area. This is not necessary, since the motor vehicle is intended to drive in an at least highly automated manner according to AVP type 1 within these regions.

Thus, installation effort for environmental sensors within the parking area can be efficiently reduced compared to the case in which the motor vehicle drives in an at least highly automated manner exclusively according to AVP type 2 within the parking area, since the motor vehicle requires environmental sensors outside the motor vehicle for this purpose.

In addition, fewer environmental sensors are required compared to the case in which the motor vehicle drives in an at least highly automated manner exclusively according to AVP type 2 within the parking area.

A parking area in the sense of the description can also be referred to as a parking space and serves as a parking space for vehicles. In particular, the parking area thus forms a contiguous area which has a plurality of parking places (in the case of a parking area on private land) or parking zones (in the case of a parking area on public land). The parking area may be included in a parking garage according to one embodiment. In particular, the parking area is included in a garage.

The abbreviation “AVP” stands for “Automated Valet Parking”. An AVP process comprises, for example, at least highly automated guidance of the motor vehicle from a drop zone, also called a drop-off position, to a parking position and, for example, at least highly automated guidance of the motor vehicle from a parking position to a pick-up position, also called a pick-up zone. At the drop-off position, i.e. the drop zone, a driver of the motor vehicle drops off the motor vehicle for an AVP process. At a pick-up position, i.e. the pick-up zone, the motor vehicle is picked up after the end of the AVP process. Thus, an AVP process starts in particular at the drop zone. An AVP process therefore ends in particular at the pick-up zone. The pick-up zone can be the same as or different from the drop zone.

An AVP motor vehicle is therefore a motor vehicle that can participate in an AVP process. If motor vehicle is written above and below, it should always be read that this is an AVP motor vehicle, even if the term “AVP” is not explicitly used.

The AVP process is carried out on the infrastructure side using or by the AVP system according to the third aspect and is carried out on the motor vehicle side using or by the AVP system according to the fourth aspect.

An AVP process can be an AVP process according to one of the following AVP types: AVP type 1, AVP type 2, and AVP type 3. However, the AVP types can also change within an AVP process. This means, for example, that one part of an AVP process is carried out according to AVP type 1 and another part of the AVP process is carried out according to an AVP type 2 or AVP type 3. This means, for example, that an AVP process can be divided into partial AVP processes which are each carried out according to one of the AVP types 1, 2 and 3.

AVP type 1 denotes a motor-vehicle-centric AVP process. The primary responsibility for the AVP process lies with the motor vehicle, i.e. the motor vehicle AVP system.

AVP type 2 denotes an infrastructure-centric AVP process. The primary responsibility for the AVP process lies with the infrastructure, i.e. the infrastructure AVP system.

AVP type 3 denotes an AVP process split between the motor vehicle and the infrastructure. Here, a primary responsibility for the AVP process is shared between the motor vehicle, i.e. the motor vehicle AVP system, and the infrastructure AVP system.

An AVP process comprises the following operations or functions:

1. Determining a target position within the parking area for the motor vehicle.

2. Planning a route from a starting position that is included in the parking area to the target position.

3. Detecting an object and/or an event and reacting accordingly to a detected object and/or a detected event.

4. Locating the motor vehicle within the parking area.

5. Calculating a target trajectory for the motor vehicle based on the planned route.

6. Controlling lateral and longitudinal guidance of the motor vehicle based on the calculated target trajectory.

The following table indicates which of these operations or functions are carried out by the motor vehicle, i.e. the motor vehicle AVP system, or the infrastructure AVP system, depending on the AVP type, where “I” stands for “infrastructure”, i.e. the infrastructure AVP system, and “K” stands for “motor vehicle”, with the result that “I” indicates that the process is carried out by the AVP system and “K” indicates that the process is carried out by the motor vehicle:

| | AVP | AVP | AVP |
|---|---|---|---|
| Functions | type 1 | type 2 | type 3 |
| Determining a target | I & K | I | I |
| position within the parking | | | |
| area for the motor vehicle. | | | |
| Planning a route from a | K | I | I |
| starting position that is | | | |
| included in the parking area | | | |
| to the target position. | | | |
| Detecting an object and/or | K (& | I | I & K |
| an event and reacting | optionally I) | | |
| accordingly to a detected | | | |
| object and/or a detected | | | |
| event. | | | |
| Locating the motor vehicle | K | I | K |
| within the parking area. | | | |
| Calculating a target | K | I | K |
| trajectory for the | | | |
| motor vehicle based | | | |
| on the planned route. | | | |
| Controlling lateral and | K | K | K |
| longitudinal guidance of the | | | |
| motor vehicle based on the | | | |
| calculated target trajectory. | | | |

The table above therefore indicates for each function, specifically for each AVP type, whether the function is performed by the infrastructure, i.e. by the infrastructure AVP system, or by the motor vehicle, i.e. by the motor vehicle AVP system. In some cases, provision may be made for the function to be performed by both the infrastructure AVP system and the motor vehicle.

With regard to object and event detection for AVP type 1, provision may optionally be made for the infrastructure AVP system of the infrastructure to also perform this function in addition to the motor vehicle.

AVP types 1, 2 and 3 described here are described in further detail in ISO 23374-2.

The motor vehicle is an at least highly automated motor vehicle. Such a motor vehicle is configured for at least highly automated guidance. Highly automated guidance corresponds to an automation level 3 as defined by the Federal Highway Research Institute (BASt).

The fact that the motor vehicle is configured at least for highly automated guidance includes the case where the motor vehicle is configured for highly automated guidance as well as for fully automated guidance and for autonomous guidance. Fully automated guidance corresponds to an automation level 4 as defined by the BASt.

Highly automated guidance means that, for a certain period of time in a specific situation (for example: driving on a freeway, driving within a parking area, overtaking an object, driving within a lane defined by lane markings), longitudinal and lateral guidance of the motor vehicle is automatically controlled. A driver of the motor vehicle does not have to manually control the longitudinal and lateral guidance of the motor vehicle himself. The driver does not have to permanently monitor the automatic control of the longitudinal and lateral guidance in order to be able to intervene manually if necessary. If necessary, a takeover request to take over the control of the longitudinal and lateral guidance is automatically output to the driver, in particular with a sufficient time reserve. This means that the driver must potentially be able to take over the control of the longitudinal and lateral guidance. Limits of the automatic control of the lateral and longitudinal guidance are automatically recognized. With highly automated guidance, it is not possible to automatically bring about a risk-minimized state in every initial situation.

The wording “to take over the control of the longitudinal and lateral guidance” can also be replaced by the wording “to take over the longitudinal and lateral guidance”.

Fully automated guidance means that, in a specific situation (for example: driving on a freeway, driving within a parking area, overtaking an object, driving within a lane defined by lane markings), longitudinal and lateral guidance of the motor vehicle is automatically controlled. A driver of the motor vehicle does not have to manually control the longitudinal and lateral guidance of the motor vehicle himself. The driver does not have to monitor the automatic control of the longitudinal and lateral guidance in order to be able to intervene manually if necessary. Before the automatic control of the lateral and longitudinal guidance is stopped, the driver is automatically prompted to take over the driving task (control of the lateral and longitudinal guidance of the motor vehicle), in particular with a sufficient time reserve. If the driver does not take over the driving task, there is an automatic return to a risk-minimized state. Limits of the automatic control of the lateral and longitudinal guidance are automatically recognized. In all situations, it is possible to automatically return to a risk-minimized system state.

Autonomous guidance or driving means that longitudinal and lateral guidance of the motor vehicle is automatically controlled in all situations and not only in one or more specific situations. The driver is no longer necessary as a fallback level. The motor vehicle can therefore drive without a driver. Autonomous guidance corresponds to an automation level 5 according to SAE (J3016), where SAE stands for “Society of Automotive Engineers”.

In one embodiment of the method according to the first aspect, provision is made for the sending to comprise sending infrastructure assistance data before the start of the AVP process and/or after the start of the AVP process and during an at least highly automated journey of the motor vehicle within the parking area before at least highly automated driving according to AVP type 1 and/or after the start of the AVP process and as part of a transfer process to AVP type 1 driving and/or during the at least highly automated journey of the motor vehicle according to AVP type 1.

This results, for example, in the technical advantage that the infrastructure assistance data are sent to the motor vehicle at particularly suitable times or time intervals.

Any information helps the motor vehicle. The motor vehicle decides/is responsible for which information is then used by the motor vehicle. This means: The information is preferably sent to the motor vehicle as quickly as possible or as soon as it is available. For example, the motor vehicle can determine a list of what information it needs and can send this list to the infrastructure, that is to say the infrastructure AVP system, which determines the appropriate information based on the list and sends it to the motor vehicle. For example, a time at which the information is sent to the motor vehicle may depend on the list.

In one embodiment of the method according to the first aspect, provision is made for the infrastructure assistance data to comprise one or more of the following items of information: digital map of the region, rules to be taken into account by the motor vehicle during the at least highly automated journey according to AVP type 1, transfer position for a transfer from AVP type 1 driving to AVP type 2 driving, where AVP type 2 is an infrastructure-centric AVP process, target position, in particular parking bay, for the motor vehicle within the region, position of a drop zone, position of a pick-up zone, target travel route within the region, target driving tube within the region, target trajectory within the region, information about a dynamic behavior in the parking area, information about an event that has taken place in the parking area, in particular an accident, information provided by a traffic control device arranged within the parking area, in particular an electronic traffic sign or light signaling system.

This results, for example, in the technical advantage that particularly suitable information is sent to the motor vehicle.

Electronic signs, such as an electronic traffic sign, with information data are useful for motor vehicles and also for drivers. An electronic sign can be used, for example, by a parking area management system to indicate where there is something free in the parking area or where there is a particularly large amount of traffic in the parking area. The information that can be displayed by such an electronic sign can be sent to the motor vehicle, for example.

In one embodiment of the method according to the first aspect, provision is made for the information about a dynamic behavior in the parking area and/or the information about an event that has taken place in the parking area to be determined by the infrastructure AVP system using one or more infrastructure environmental sensors in the parking area and/or to be received by the infrastructure AVP system from one or more further motor vehicles located within the parking area and/or to be received by the infrastructure AVP system from an online map service and/or from an (online) data source, in particular an OEM backend and/or a terminal belonging to a person who has reported the information via their terminal.

This results, for example, in the technical advantage that the information can be determined efficiently.

For example, motor vehicles that are located within the region can capture their respective environment using their respective motor vehicle environmental sensor system and can send environmental data based on the capture to the infrastructure AVP system which receives said data accordingly. For example, the infrastructure AVP system can send these environmental data to the motor vehicle as infrastructure assistance data.

In one embodiment of the method according to the second aspect, provision is made for the receiving to comprise receiving infrastructure assistance data before the start of the AVP process and/or after the start of the AVP process and during an at least highly automated journey of the motor vehicle within the parking area before at least highly automated driving according to AVP type 1 and/or after the start of the AVP process and as part of a transfer process to AVP type 1 driving and/or during the at least highly automated journey of the motor vehicle according to AVP type 1.

This results, for example, in the technical advantage that the infrastructure assistance data are received by the motor vehicle AVP system at particularly suitable times or time intervals.

In one embodiment of the method according to the second aspect, provision is made for the infrastructure assistance data to comprise one or more of the following items of information: digital map of the region, rules to be taken into account by the motor vehicle during the at least highly automated journey according to AVP type 1, transfer position for a transfer from AVP type 1 driving to AVP type 2 driving, where AVP type 2 is an infrastructure-centric AVP process, target position, in particular parking bay, for the motor vehicle within the region, position of a drop zone, position of a pick-up zone, target travel route within the region, target driving tube within the region, target trajectory within the region, information about a dynamic behavior in the parking area, information about an event that has taken place in the parking area, in particular an accident, information provided by a traffic control device arranged within the parking area, in particular an electronic traffic sign or light signaling system, and/or by an (online) data source, in particular an OEM backend and/or a terminal belonging to a person who has reported the information via their terminal.

This results, for example, in the technical advantage that particularly suitable infrastructure assistance data are received.

In one embodiment of the method according to the second aspect, provision is made for an at least highly automated journey of the motor vehicle according to AVP type 1 through the region to be replanned by the motor vehicle AVP system or for an already planned at least highly automated journey of the motor vehicle according to AVP type 1 to be adapted by the motor vehicle AVP system based on the infrastructure assistance data, wherein the motor vehicle AVP system drives the motor vehicle in an at least highly automated manner according to AVP type 1 through the region based on the replanned journey or based on the adapted journey.

This results, for example, in the technical advantage that the motor vehicle AVP system can drive the motor vehicle efficiently in an at least highly automated manner according to AVP type 1 within the region.

Statements made in connection with the first aspect apply analogously to embodiments of the method according to the second aspect and vice versa.

At this point, it is noted that, if it is written above and/or below that the motor vehicle carries out a certain step or certain steps, this shall mean that these steps are carried out using the motor vehicle AVP system. The method steps of the method according to the second aspect are thus carried out by the motor vehicle AVP system.

Accordingly, the method steps of the method according to the first aspect are carried out using, in particular by, the infrastructure AVP system.

In one embodiment, the motor vehicle AVP system comprises a control unit for at least highly automated control of lateral and longitudinal guidance of the motor vehicle.

Statements made in connection with the method according to the first aspect apply analogously to the method according to the second aspect and vice versa. This means that the technical functionalities and features of the method according to the second aspect result from corresponding technical functionalities of the method according to the first aspect and vice versa.

For example, sending and receiving in the sense of the description is sending and receiving via one or more communication networks. A communication network is, for example, a WLAN network or a mobile radio network.

The motor vehicle AVP system is configured in terms of programming, for example, to execute the computer program according to the sixth aspect which comprises instructions which, when the computer program is executed by a computer, cause the latter to carry out a method according to the second aspect.

The infrastructure AVP system is configured in terms of programming, for example, to execute the computer program according to the sixth aspect which comprises instructions which, when the computer program is executed by a computer, cause the latter to carry out a method according to the first aspect.

The method according to the first aspect and/or the method according to the second aspect is or are, for example, computer-implemented methods.

The motor vehicle comprises, for example, one or more environmental sensors. Such environmental sensors can also be called motor vehicle environmental sensors. Such environmental sensors are included, for example, in the motor vehicle AVP system. A motor vehicle environmental sensor system comprises, for example, one or more such environmental sensors.

The infrastructure AVP system comprises, for example, one or more environmental sensors which are spatially distributed within the parking area. Such environmental sensors can be referred to, for example, as infrastructure environmental sensors. An infrastructure environmental sensor system comprises, for example, one or more such infrastructure environmental sensors.

For example, the region through which the motor vehicle drives according to AVP type 1 does not have any infrastructure environmental sensors.

An environmental sensor, i.e. a motor vehicle environmental sensor or an infrastructure environmental sensor, is, for example, one of the following environmental sensors: radar sensor, lidar sensor, image sensor, in particular image sensor of a video camera, for example image sensors of a stereo video camera, ultrasonic sensor, magnetic field sensor, infrared sensor.

The embodiments and exemplary embodiments described here can be combined in any manner with one another, even if this is not explicitly described.

A region within which a motor vehicle is intended to drive in an at least highly automated manner according to AVP type 1 can also be referred to as an AVP type 1 region. For such a region, for example, there is no AVP infrastructure monitoring by infrastructure environmental sensors.

A region within which a motor vehicle is intended to drive in an at least highly automated manner according to AVP type 2 can also be referred to as an AVP type 2 region. For such a region, there is AVP infrastructure monitoring by infrastructure environmental sensors.

AVP infrastructure monitoring is monitoring by one or more infrastructure environmental sensors, wherein the monitoring data determined in the monitoring are used for the AVP process.

This may mean that there may indeed be infrastructure environmental sensors within an AVP type 1 region. However, these are not used for AVP infrastructure monitoring. One reason may be, for example, that these infrastructure environmental sensors do not meet certain safety requirements that AVP infrastructure monitoring should or can advantageously meet. Such safety requirements include, for example, one or more specific safety levels. Safety levels are, for example, the following safety levels: QM, ASIL-A, ASIL-B, ASIL-C, ASIL-D, SIL-1, SIL-2, SIL-3.

The abbreviation “ASIL” stands for “Automotive Safety Integrity Level”. “Automotive Safety Integrity Level” is a key component of the ISO 26262 standard. ASIL distinguishes between four different ASIL risk levels, denoted by ASIL-A, ASIL-B, ASIL-C and ASIL-D.

The abbreviation “SIL” stands for “Safety Integrity Level”. “Safety Integrity Level” is a key component of the IEC EN 61508 standard. SIL distinguishes between four different SIL risk levels, denoted by SIL-1, SIL-2, SIL-3 and SIL-4.

QM stands for “Quality Management”, which means in particular that risks are tolerable, and so special safety requirements are unnecessary and only standard quality requirements are sufficient.

Infrastructure environmental sensors used for AVP monitoring comply, for example, with a higher safety level than infrastructure environmental sensors that are not used for AVP monitoring, but rather, for example, to detect occupancy of a parking place.

At least highly automated driving of the motor vehicle by the motor vehicle AVP system comprises, for example, at least highly automated control of lateral and longitudinal guidance of the motor vehicle by the motor vehicle AVP system.

The infrastructure AVP system of the method according to the first aspect is the AVP system for an infrastructure, in particular a parking area, according to the third aspect. That is to say, the AVP system according to the third aspect can be referred to as an infrastructure AVP system if it is implemented in an infrastructure, in particular a parking area.

The motor vehicle AVP system of the method according to the second aspect is the AVP system for a motor vehicle according to the fourth aspect. That is to say, the AVP system according to the fourth aspect can be referred to as a motor vehicle AVP system if it is implemented in a motor vehicle.

A method in the sense of the description is carried out, for example, by way of the corresponding AVP system.

The invention will be explained in more detail below with reference to preferred exemplary embodiments. In this case:

FIG. 1 shows a flowchart of a method according to the first aspect,

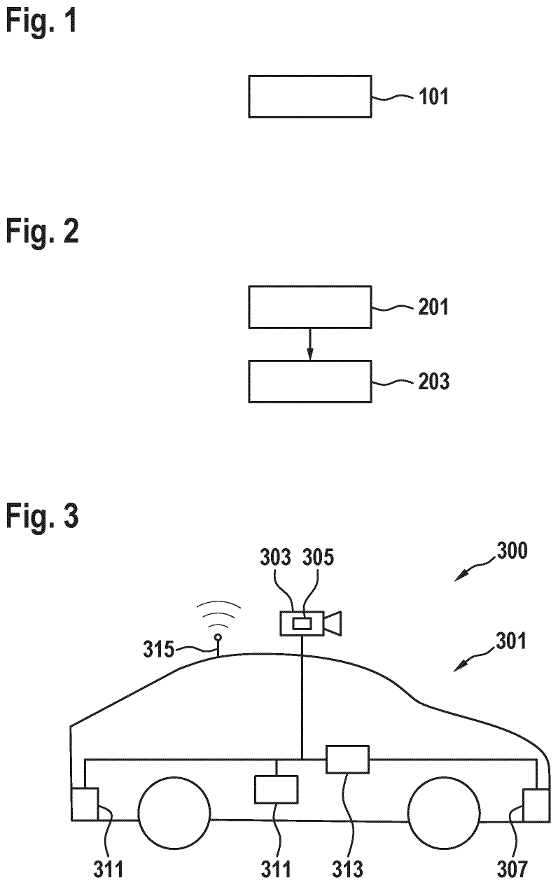

FIG. 2 shows a flowchart of a method according to the second aspect,

FIG. 3 shows an AVP system according to the fourth aspect,

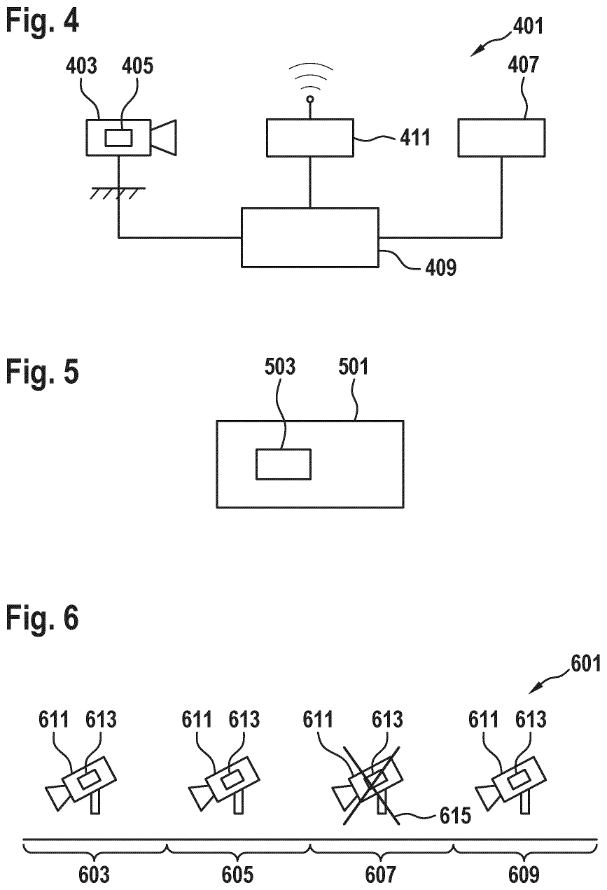

FIG. 4 shows an AVP system according to the third aspect,

FIG. 5 shows a machine-readable storage medium according to the seventh aspect,

FIG. 6 shows a parking area.

The same reference signs can be used for the same features below.

FIG. 1 shows a flowchart of a method for infrastructure-based assistance of a motor vehicle for an at least highly automated journey according to AVP type 1 within a region of a parking area, wherein AVP type 1 is a motor-vehicle-centric AVP process, comprising the following step of:
an infrastructure AVP system sending 101 infrastructure assistance data to the motor vehicle, on the basis of which the motor vehicle can drive in an at least highly automated manner according to AVP type 1 within the region.

FIG. 2 shows a flowchart of a method for at least highly automated driving of a motor vehicle according to AVP type 1 within a region of a parking area, comprising the following steps of:
a motor vehicle AVP system of the motor vehicle receiving 201 infrastructure assistance data from an infrastructure AVP system of the parking area, on the basis of which the motor vehicle AVP system can drive the motor vehicle in an at least highly automated manner according to AVP type 1 within the region, the motor vehicle AVP system driving 203 the motor vehicle in an at least highly automated manner according to AVP type 1 within the region based on the infrastructure assistance data.

At least highly automated driving of the motor vehicle by the motor vehicle AVP system comprises, for example, at least highly automated control of lateral and longitudinal guidance of the motor vehicle by the motor vehicle AVP system.

FIG. 3 shows an AVP system 300 according to the fourth aspect which is included or implemented in a motor vehicle 301 according to the fifth aspect.

By way of example, the motor vehicle AVP system 300 comprises a video camera 303 comprising an image sensor 305. The video camera 303 is arranged on the roof of the motor vehicle 301.

The motor vehicle AVP system 300 further comprises, by way of example, a first radar sensor 307 which is arranged on the front of the motor vehicle 301. The motor vehicle AVP system 300 further comprises, by way of example, a second radar sensor 309 which is arranged on the rear of the motor vehicle 301. The motor vehicle AVP system 300 further comprises, by way of example, an ultrasonic sensor 311 which is arranged on the side of the motor vehicle 301.

Thus, the motor vehicle AVP system 300 comprises a motor vehicle environmental sensor system comprising multiple environmental sensors: image sensor 305, radar sensors 307, 309, and ultrasonic sensor 311.

These environmental sensors capture an environment of the motor vehicle and output environmental sensor data based on the capture to a control unit 313 of the motor vehicle AVP system 300. The control unit 313 processes these environmental sensor data in order to guide the motor vehicle in an at least highly automated manner.

The motor vehicle AVP system 300 further comprises a wireless communication interface 315 which is configured to communicate with an infrastructure AVP system (not shown).

Communication in the sense of the description comprises sending and receiving.

At this point, it is noted that more or fewer and/or other environmental sensors can be provided instead of or in addition to the environmental sensors shown in FIG. 3.

At this point, it is noted that multiple control units can be provided instead of or in addition to the control unit 313 shown in FIG. 3.

In an embodiment that is not shown, provision is made for the motor vehicle AVP system 300 to not comprise any motor vehicle environmental sensors. In this case, the motor vehicle environmental sensors are already part of the motor vehicle 301.

FIG. 4 shows an AVP system 401 according to the third aspect. The AVP system 401 is configured to perform all the steps of the method according to the first aspect.

By way of example, the AVP system 401 comprises a video camera 403 comprising an image sensor 405. By way of example, the AVP system 401 comprises a radar sensor 407.

These environmental sensors are spatially distributed within a parking area (not shown) and each capture a region of the parking area. Environmental sensor data based on the capture from these environmental sensors are output to a data processing device 409 which processes the environmental sensor data and, for example based thereon, determines infrastructure assistance data for assisting an at least highly automated motor vehicle during an AVP process.

At this point, it is noted that more or fewer and/or other environmental sensors can be provided instead of or in addition to the environmental sensors shown in FIG. 4.

The infrastructure AVP system 401 further comprises a wireless communication interface 411 which is configured to communicate with one or more at least highly automated motor vehicles which are located within the parking area.

For example, the AVP system 401 comprises a plurality of such wireless communication interfaces 411 which are spatially distributed within the parking area in order to achieve sufficient radio coverage.

The data processing device 409 may comprise, for example, one or more servers, one or more of which, for example, can be implemented in a cloud infrastructure.

In an embodiment that is not shown, provision is made for the AVP system 401 to not comprise any infrastructure environmental sensors. In this case, the infrastructure environmental sensors are already part of the parking area.

The region of the parking area within which the motor vehicle drive or drives according to AVP type 1 is not equipped in particular with such infrastructure environmental sensors.

FIG. 5 shows a machine-readable storage medium 501 according to the seventh aspect, on which a computer program 503 according to the sixth aspect is stored.

FIG. 6 shows a parking area.

Multiple regions are established or defined within the parking area 601, wherein an at least highly automated motor vehicle is intended to drive within these regions as part of an AVP process either according to AVP type 1 or according to AVP type 2.

Specifically, four such regions are defined: a first region 603, a second region 605, a third region 607 and a fourth region 609, each arranged successively directly adjacent to each other.

The first region 603 indicates a drop zone of the parking area 601. At the drop zone 603, a driver of his motor vehicle drops off his motor vehicle or parks it within this zone. The AVP process starts at the drop zone.

As part of the AVP process, the motor vehicle is intended to park within the fourth region 609, by way of example, since this indicates a parking place in the parking area 601 according to the exemplary embodiments shown here.

A second region 605 and a third region 607 are thus defined between the drop zone and the parking place.

FIG. 6 depicts a plurality of video cameras 611 each comprising an image sensor 613. In detail, such a video camera 611 is depicted for each of the regions shown in FIG. 6. At this point, it is noted that other and/or further environmental sensors can be provided instead of or in addition to the video camera 611.

The video cameras 611 shown are intended to symbolize that there is or is not monitoring by infrastructure environmental sensors for the corresponding region. If there is no such monitoring, the video camera 611 accordingly shown is crossed with an “X” with the reference sign 615.

Within those regions for which no AVP infrastructure monitoring by infrastructure environmental sensors is provided, the motor vehicle is intended to drive as part of the AVP process according to AVP type 1. For the other regions, the motor vehicle is intended to drive according to AVP type 2.

There is no AVP infrastructure monitoring for the third region 607. Here, the motor vehicle is intended to drive according to AVP type 1. There is AVP infrastructure monitoring for the other regions. Here, the motor vehicle is intended to drive according to AVP type 2.

The concept described here provides in particular for the infrastructure, i.e. the infrastructure AVP system, to provide the motor vehicle or the motor vehicle AVP system with data, the infrastructure assistance data, for an at least highly automated journey according to AVP type 1 in a region of the parking area in which, in particular, no AVP infrastructure assistance is available, on the basis of which, i.e. the data, it can carry out its driving task.

For example, provision is made for the infrastructure AVP system to provide, that is to say send, infrastructure assistance data to the motor vehicle AVP system before entering or before transitioning to an AVP type 1 region and/or during the journey within the AVP type 1 region.

For example, infrastructure assistance data comprise one or more of the following items of data or information:

Digital map of the parking area or the region with static information relating to the region. This means that the digital map comprises information about, for example, static objects located within the region. Such static objects are, for example: masonry, wall, pillar, generally infrastructure element.

Rules that must be taken into account in the parking area or within the region (e.g. speed, right of way, etc.). For example, these rules can be included in the digital map.

Position of a transition point between the AVP type 1 region and a directly adjacent AVP type 2 region, i.e. a region within which the motor vehicle is intended to drive according to AVP type 2 and for which there is AVP infrastructure monitoring. For example, this position is included in the digital map.

Target position, i.e. for example the parking position, e.g. the parking position of a parking bay, at which the motor vehicle is intended to park. For example, the target position can be changed by the infrastructure AVP system during the journey of the motor vehicle, in which case the new target position is sent to the motor vehicle AVP system by the infrastructure AVP system.

A position, i.e. in particular a parking position, a target position, a position of a transition point, in the sense of the description is, for example, included in a digital map of the parking area, that is to say is indicated by such a map.

Parking position, for example the parking position of a parking bay, at which the motor vehicle is intended to park. For example, the parking position can be changed by the infrastructure AVP system during the journey of the motor vehicle, in which case the new parking position is sent to the motor vehicle AVP system by the infrastructure AVP system.

Position of a drop zone or pick-up zone.

Target travel route within the region, i.e. a route that is intended to be traveled by the motor vehicle.

Target driving tube within which the motor vehicle is intended to drive during its journey through the AVP type 1 region. For example, the target driving tube includes the target travel route.

Target trajectory within the region. The target trajectory specifies, for example, one or more speeds, in particular depending on a location of the region, and/or one or more maximum permissible accelerations, in particular depending on a location of the region. This means that the target trajectory specifies, for example, where within the region the motor vehicle is intended to drive at what speed and/or where within the region what maximum permissible acceleration must be observed by the motor vehicle.

Dynamic behavior in the parking area and events. An example of an event is an accident.

For example, the infrastructure assistance data can be determined using one or more infrastructure environmental sensors, but their monitoring data are not used for an AVP process because these infrastructure environmental sensors do not comply with a certain safety level, for example. For example, the infrastructure assistance data can be received by the infrastructure AVP system alternatively or additionally from other sources, for example other motor vehicles, that are located within the parking area or the region and/or from one or more digital map services.

Data from one or more traffic control devices, in particular an electronic traffic sign, a light signaling system, which are located within the parking area. Such data include, for example, a current and/or future signal image from the light signaling system and/or information displayed by the electronic traffic sign and/or from an (online) data source, in particular an OEM backend and/or a terminal belonging a person who has reported the information via their terminal.

Based on the transmitted infrastructure assistance data, in particular digital map and/or target travel route and/or target driving tube and/or target trajectory, the motor vehicle is driven by the motor vehicle AVP system in an at least highly automated manner according to AVP type 1 within the region.

For example, the motor vehicle AVP system continuously adapts the behavior of the motor vehicle and/or planning of the journey and/or control of one or more actuators, in particular the drive, brake, steering, of the motor vehicle based on the transmitted infrastructure assistance data.

For example, the infrastructure assistance data can be sent to the motor vehicle AVP system by the infrastructure AVP system at one or more of the following times or time intervals: For example, the infrastructure assistance data are already in advance of the AVP process and/or after the start of the AVP process during the at least highly automated journey of the motor vehicle, in particular according to AVP type 2, within the parking area before entering AVP type 1 and/or when transferring the responsibility for driving from the infrastructure to the motor vehicle, i.e. from the infrastructure AVP system to the motor vehicle AVP system, and/or during the journey of the motor vehicle according to AVP type 1 within the region.

The infrastructure assistance data are sent, for example, once or multiple times, in particular at the above-mentioned times or time intervals. If more up-to-date infrastructure assistance data are available on the infrastructure side than those already sent, provision is made, for example, for the more up-to-date infrastructure assistance data to be sent to the motor vehicle AVP system by the infrastructure AVP system. For example, the infrastructure AVP system updates the infrastructure assistance data such that more up-to-date infrastructure assistance data than the data already sent are available.

1. A method for infrastructure-based assistance of a motor vehicle for an at least highly automated journey according to AVP type 1 within a region of a parking area, wherein AVP type 1 is a motor-vehicle-centric AVP process, comprising the following step of:
an infrastructure AVP system sending infrastructure assistance data to the motor vehicle, on the basis of which the motor vehicle can drive in an at least highly automated manner according to AVP type 1 within the region.

2. The method as claimed in claim 1, wherein the sending comprises sending infrastructure assistance data before the start of the AVP process and/or after the start of the AVP process and during an at least highly automated journey of the motor vehicle within the parking area before at least highly automated driving according to AVP type 1 and/or after the start of the AVP process and as part of a transfer process to AVP type 1 driving and/or during the at least highly automated journey of the motor vehicle according to AVP type 1.

3. The method as claimed in claim 1, wherein the infrastructure assistance data comprise one or more of the following items of information: digital map of the region, rules to be taken into account by the motor vehicle during the at least highly automated journey according to AVP type 1, transfer position for a transfer from AVP type 1 driving to AVP type 2 driving, where AVP type 2 is an infrastructure-centric AVP process, target position, in particular parking bay, for the motor vehicle within the region, position of a drop zone, position of a pick-up zone, target travel route within the region, target driving tube within the region, target trajectory within the region, information about a dynamic behavior in the parking area, information about an event that has taken place in the parking area, in particular an accident, information provided by a traffic control device arranged within the parking area, in particular an electronic traffic sign or light signaling system.

4. The method as claimed in claim 3, wherein the information about a dynamic behavior in the parking area and/or the information about an event that has taken place in the parking area is determined by the infrastructure AVP system using one or more infrastructure environmental sensors in the parking area and/or is received by the infrastructure AVP system from one or more further motor vehicles located within the parking area and/or is received by the infrastructure AVP system from an online map service and/or from an online data source, in particular an OEM backend and/or a terminal belonging to a person who has reported the information via their terminal.

5. A method for at least highly automated driving of a motor vehicle according to AVP type 1 within a region of a parking area, comprising the following steps of:
a motor vehicle AVP system of the motor vehicle receiving infrastructure assistance data from an infrastructure AVP system of the parking area, on the basis of which the motor vehicle AVP system can drive the motor vehicle in an at least highly automated manner according to AVP type 1 within the region,
the motor vehicle AVP system driving the motor vehicle in an at least highly automated manner according to AVP type 1 within the region based on the infrastructure assistance data.

6. The method as claimed in claim 5, wherein the receiving comprises receiving infrastructure assistance data before the start of the AVP process and/or after the start of the AVP process and during an at least highly automated journey of the motor vehicle within the parking area before at least highly automated driving according to AVP type 1 and/or after the start of the AVP process and as part of a transfer process to AVP type 1 driving and/or during the at least highly automated journey of the motor vehicle according to AVP type 1.

7. The method as claimed in claim 5, wherein the infrastructure assistance data comprise one or more of the following items of information: digital map of the region, rules to be taken into account by the motor vehicle during the at least highly automated journey according to AVP type 1, transfer position for a transfer from AVP type 1 driving to AVP type 2 driving, where AVP type 2 is an infrastructure-centric AVP process, target position, in particular parking bay, for the motor vehicle within the region, position of a drop zone, position of a pick-up zone, target travel route within the region, target driving tube within the region, target trajectory within the region, information about a dynamic behavior in the parking area, information about an event that has taken place in the parking area, in particular an accident, information provided by a traffic control device arranged within the parking area, in particular an electronic traffic sign or light signaling system, and/or by an online data source, in particular an OEM backend and/or a terminal belonging to a person who has reported the information via their terminal.

8. The method as claimed in claim 5, wherein an at least highly automated journey of the motor vehicle according to AVP type 1 through the region is replanned by the motor vehicle AVP system or an already planned at least highly automated journey of the motor vehicle according to AVP type 1 is adapted by the motor vehicle AVP system based on the infrastructure assistance data, wherein the motor vehicle AVP system drives the motor vehicle in an at least highly automated manner according to AVP type 1 through the region based on the replanned journey or based on the adapted journey.

9. An AVP system for an infrastructure, in particular a parking area, which is configured to carry out all the steps of the method as claimed in claim 1.

10. An AVP system for a motor vehicle, wherein the AVP system is configured to carry out all the steps of the method as claimed in claim 5.

11. A motor vehicle comprising the AVP system as claimed in claim 10.

12. A computer program comprising instructions which, when the computer program is executed by a computer, cause the latter to perform a method as claimed in one of claims 1 to 8 claim 1.

13. A machine-readable data storage medium on which the computer program as claimed in claim 12 is stored.
